(19) United States
(12) Patent Application Publication
(10) Pub. No.: US 2002/0079678 A1
(43) Pub. Date: Jun. 27, 2002

(54) Air bag device

(75) Inventors: Takeshi Kai, Wako-shi (JP); Toshiya Sakai, Wako-shi (JP); Hiroyuki Saitoh, Wako-shi (JP); Masahiro Sato, Wako-shi (JP)

Correspondence Address: CARRIER BLACKMAN AND ASSOCIATES, 24101 NOVI ROAD, SUITE 100, NOVI, MI, 48375

(73) Assignee: Honda Giken Kogyo Kabushiki Kaisha, Tokyo (JP)

(21) Appl. No.: 09/974,262

(22) Filed: Oct. 9, 2001

(30) Foreign Application Priority Data
Oct. 10, 2000 (JP) 2000-309629

(51) Int. Cl. B60R 21/16

(52) U.S. Cl. 280/731; 280/743.2

(57) ABSTRACT

An air bag device having a switch adapted to be operated when a breakable cover member covering an air bag module mounted in the steering wheel is pushed. Particularly, H-shaped tear lines, including grooves of a V-shape in section, are defined in an inner surface of the cover member. The tear lines are broken by a pressure resulting from the expansion of the air bag to open a lid defined in the cover member. A pair of ridges are integrally formed on the cover member astride a central one of the tear lines. The rigidity of the rear cover member is enhanced by the ridges, whereby the deformation of the cover member is prevented. Thus, the cover member can be slid smoothly to ensure the reliable operation of the switch.

### BACKGROUND OF THE INVENTION

1. Field of the Invention

The present invention relates to an air bag device designed so that upon collision of a vehicle an air bag is deployed into a vehicle compartment through an opening resulting from the breaking of a cover member mounted on a steering wheel.

2. Description of Relevant Art

There is a conventionally known air bag device in which an air bag module including an air bag and an inflator is accommodated in a central portion of a steering wheel, and a cover member in the steering wheel is broken by a pressure generated by the expansion of the air bag upon collision of a vehicle, thereby permitting the air bag to deploy into a vehicle compartment. In such air bag device, in order to reliably break the cover member by the pressure generated by the expansion of the air bag, a tear line comprising a brittle groove is formed in an inner surface of the cover member (surface opposed to the air bag module (see Japanese Patent Application Laid-open No. 4-90942).

In common, switches for operating a horn for an automobile are mounted on laterally opposite sides of a center portion of a steering wheel, so that they are easily operated by left and right thumbs of a driver. However, such arrangement of the switches is accompanied by a problem that it is difficult to operate the switches in a state in which the steering wheel has been turned from a neutral position. Therefore, it is considered that the air bag device may be of an arrangement such that the entire cover member covering the air bag module is mounted for sliding movement relative to a module-supporting member fixed to the steering wheel and having the air bag module accommodated therein, so that even if any portion of the cover member is pushed, the switches are operated.

When the above arrangement is employed, however, the rigidity of the cover member is reduced due to the tear line. For this reason, there is a possibility that only the portion of the cover member pushed by the fingers is depressed, whereby the entire cover member is not slid smoothly relative to the module-supporting member and as a result, the switches are not operated properly.

### SUMMARY OF THE INVENTION

The present invention has been accomplished with the above circumstance in view, and it is an object of the present invention to provide an air bag device adapted to be mounted in a steering wheel provided with a switch, wherein the rigidity of the cover member is enhanced to ensure the reliable operation of the switch, while also reliably permitting the breaking of the cover member along a tear line.

To achieve the above object, according to a first aspect and feature of the present invention, there is provided an air bag device comprising an air bag module including an air bag and an inflator formed integrally with each other, a module-supporting member mounted at a central portion of a steering wheel of a vehicle for supporting the air bag module, a cover member slidably supported on the module-supporting member to cover the air bag module, groove-shaped tear lines formed in an inner surface of the cover member, and a switch adapted to be operated when the cover member is pushed and slid relative to the module-supporting member, the air bag, as expanded by a high-pressure gas generated by the inflator upon collision of a vehicle breaks the cover member along the tear lines to deploy into a compartment of the vehicle, wherein the cover member has at least one rigidity enhancing ridge integrally formed on the inner surface thereof astride the tear lines.

With the above arrangement, the ridge is formed on the inner surface of the cover member astride the tear lines to enhance the rigidity of the cover member. Therefore, when the cover member is pushed, it can be slid relative to the module-supporting member without being deformed, thereby properly operating the switch. The ridge protrudes from a back of the cover member and hence, the rigidity of the cover member can be enhanced, and an aesthetic appearance of the cover is not impaired. When the air bag is expanded to break the cover along the tear lines, the ridge provided astride the tear lines is also broken and hence, the air bag can be deployed without hindrance.

According to a second aspect and feature of the present invention, in addition to the first aspect and feature, a groove is defined in a side face of the ridge and connected to a bottom of the tear line.

With the above arrangement, the groove is defined in the side of the ridge and connected to the bottom of the tear line and hence, when the tear lines are broken, the ridge can be broken reliably without reducing the normal rigidity of the unbroken cover member.

According to a third aspect and feature of the present invention, there is provided an air bag device for a vehicle comprising an air bag module including an air bag and an inflator formed integrally with each other, a module-supporting member mounted at a central portion of a steering wheel of the vehicle for supporting the air bag module, a cover member slidably supported on the module-supporting member to cover the air bag module, groove-shaped tear lines formed in an inner surface of the cover member, and a switch adapted to be operated when the cover member is pushed and slid relative to the module-supporting member, the air bag, as expanded by a high-pressure gas generated by the inflator upon collision of the vehicle breaks the cover member along the tear lines to deploy into a compartment of the vehicle, and the cover member has reinforcing ribs integrally formed on the inner surface thereof so that they do not intersect the tear lines.

With the above arrangement, the reinforcing ribs are integrally formed on the inner surface of the cover member so that they do not intersect the tear lines, thereby enhancing the rigidity of the cover member. Therefore, when the cover member is pushed, it can be slid relative to the module-supporting member without being deformed, thereby properly operating the switch. When the air bag is expanded to break the cover along the tear lines, the reinforcing ribs, which do not intersect the tear lines, do not impede the breaking of the tear lines and hence, it is possible to deploy the air bag without hindrance. Moreover, the reinforcing ribs are formed on the inner surface of the cover member and hence, there is not a possibility that they would impair the aesthetic appearance of the cover.

According to a fourth aspect and feature of the present invention, in addition to the third aspect and feature, at least a portion of the reinforcing ribs is formed to extend along the tear lines.

With the above arrangement, at a least portion of the reinforcing ribs is formed to extend along the tear lines and hence, portions of the cover member in the vicinity of the tear lines are reinforced by the reinforcing ribs, and the rigidity of the cover member can be enhanced effectively.

A rear cover member in each of the embodiments disclosed below corresponds to the cover member of the present invention.

Other objects, advantages and salient features of the invention will be apparent from the following detailed description which, in conjunction with the annexed drawings, discloses the present embodiments of the invention.

### BRIEF DESCRIPTION OF DRAWINGS

FIG. 1 is a perspective view of a front portion of a passenger compartment of an automobile.

FIG. 2 is an enlarged sectional view taken along a line 2-2 in FIG. 1.

FIG. 3 is an exploded perspective view of an air bag device for a driver's seat.

FIG. 4 is an enlarged view of a portion indicated by arrow 4 in FIG. 2.

FIG. 5 is a view taken along a line 5-5 in FIG. 2.

FIG. 6 is an enlarged sectional view taken along a line 6-6 in FIG. 5.

FIG. 7 is a view similar to FIG. 5, but according to a second embodiment of the present invention.

FIG. 8 is an enlarged sectional view taken along a line 8-8 in FIG. 7.

FIGS. 9A and 9B are views similar to FIG. 5, but according to third and fourth embodiments of the present invention.

FIG. 10 is a view similar to FIG. 5, but according to a fifth embodiment of the present invention.

FIG. 11 is an enlarged sectional view taken along a line 11-11 in FIG. 10.

FIGS. 12A and 12B are views for explaining the operation of the fifth embodiment of the present invention.

### DETAILED DESCRIPTION OF THE CURRENT EMBODIMENTS

The mode for carrying out the present invention will now be described by way of embodiments of the present invention shown in the accompanying drawings.

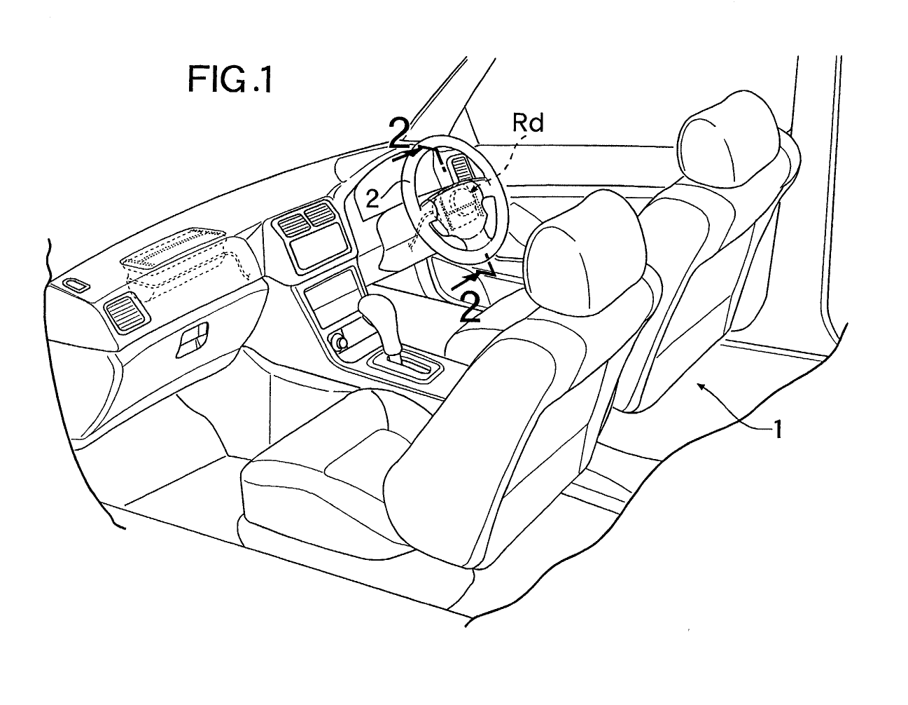

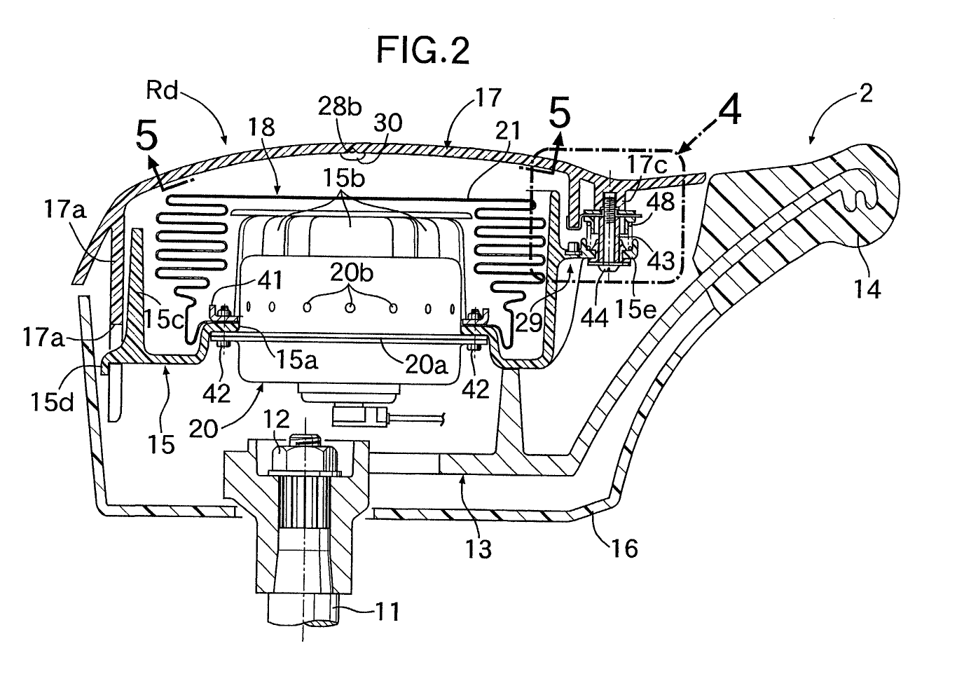

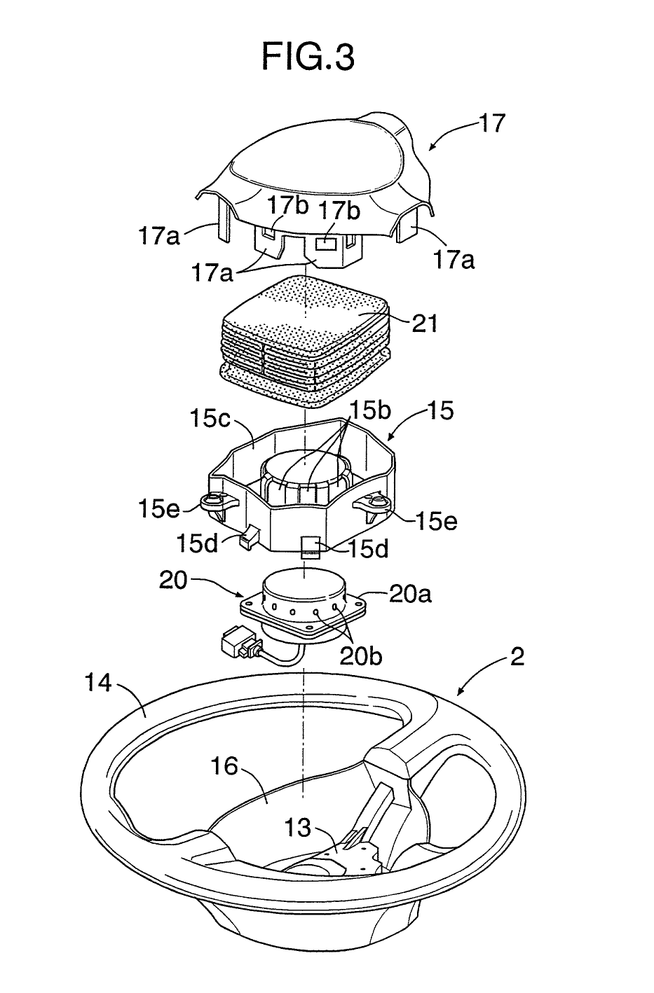

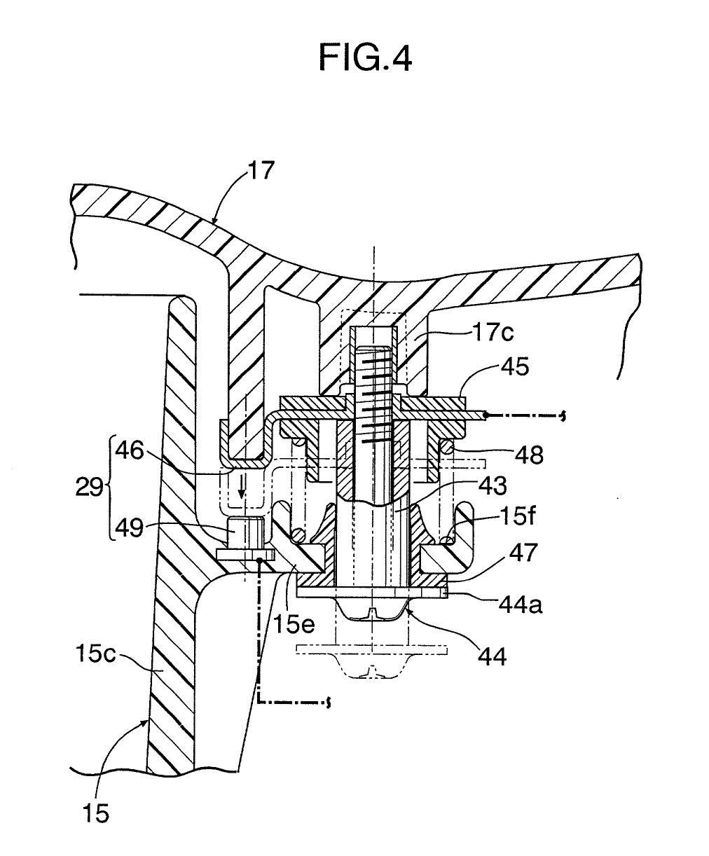

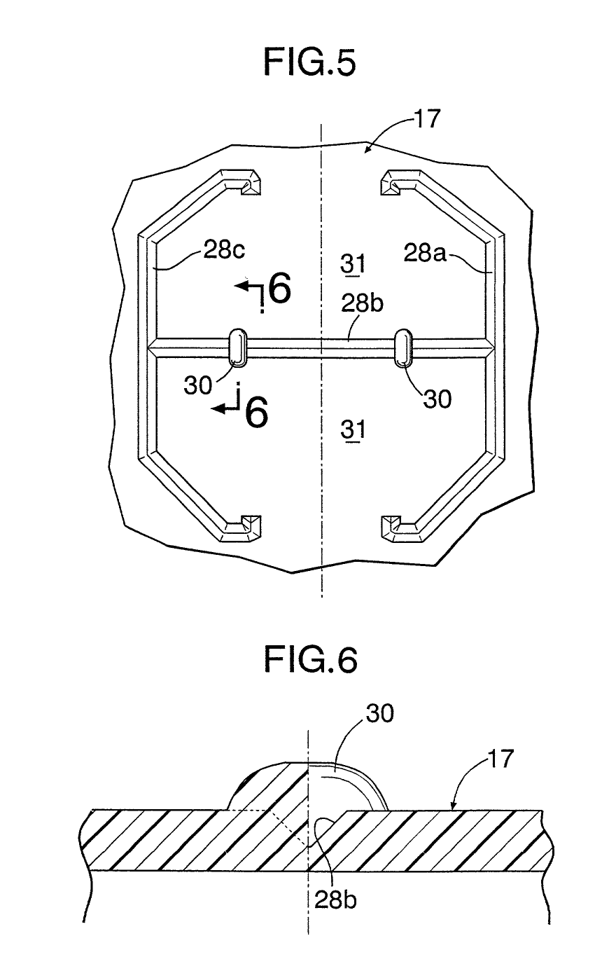

FIGS. 1 to 6 show a first embodiment of the present invention. FIG. 1 is a perspective view of a front portion of a passenger compartment of an automobile; FIG. 2 is an enlarged sectional view taken along a line 2-2 in FIG. 1; FIG. 3 is an exploded perspective view of an air bag device for a driver's seat; FIG. 4 is an enlarged view of a portion indicated by arrow 4 in FIG. 2; FIG. 5 is a view taken along a line 5-5 in FIG. 2; and FIG. 6 is an enlarged sectional view taken along a line 6-6 in FIG. 5.

As shown in FIGS. 1 to 4, an air bag device Rd for a driver's seat 1 is mounted at a central portion of a steering wheel 2 disposed in front of the driver's seat 1. The steering wheel 2 includes a steering boss 13 relatively non-rotatably fitted over and fixed to a rear end of a steering shaft 11 by a nut 12, an annular wheel rim 14 disposed to surround the steering boss 13, a cup-shaped module-supporting member 15 fixed to a rear surface of the steering boss 13, a front cover member 16 covering a front surface of the steering boss 13, and a rear cover member 17 covering a rear surface of the module-supporting member 15. An air bag module 18 is accommodated in a space surrounded by the module-supporting member 15 and the rear cover member 17.

The air bag module 18 is comprised of an inflator 20 adapted to generate a high-pressure gas, and an air bag 21 adapted to be expanded by the high-pressure gas generated by the inflator 20. The inflator 20 is fitted into a circular mounting bore 15a in the module-supporting member 15, and a flange 20a of the inflator 20, the mounting bore 15a in the module-supporting member 15, a peripheral edge of an opening in the air bag 21 and a ring-shaped retainer 41 are superposed one on another and clamped together by a plurality of bolts 42. The inflator 20 has gas-ejecting ports 20b, which communicate with an internal space in the air bag 21 through openings 15b in the module-supporting member 15.

A plurality of guide projections 15d are provided on a wall 15c of the module-supporting member 15, and a plurality of elongated bores 17b defined in a wall 17a of the rear cover member 17 are slidably engaged with the guide projections 15d. Collars 43 are fixed by bolts 44 to three bosses 17c projectingly provided on a back of the rear cover member 17, and spring seats 45 are clamped between one ends of the collars 43 and the bosses 17c. Movable contacts 46 are integrally molded in the spring seats 45. Bushes 47 are fitted over three flanges 15e projectingly provided on the wall 15c of the module-supporting member 15, so that collars 43 are slidably guided on the bushes 47. Coil springs 48 are disposed between the spring seats 45 and spring seats 15f formed on the flanges 15e to bias the rear cover member 17 away from the module-supporting member 15. At that time, the falling-out of bolts 44 from the bushes 47 is prevented by abutment of collars 44a integrally formed on heads of the bolts 44 against the bushes 47. Stationary contacts 49 provided at base ends of the flanges 15e are opposed to the movable contacts 46, so that they can be put into abutment against the movable contacts 46. The stationary contacts 49 and the movable contacts 46 constitute three switches 29 for a horn by cooperation with each other.

As can be seen from FIGS. 5 and 6, substantially H-shaped tear lines 28a, 28b and 28c are formed in an inner surface of the rear cover member 17 and each have a V-shaped section. The thickness of the rear cover member 17, made of a synthetic resin, is decreased at the tear lines so that the rear cover member 17 can be easily broken by the air bag when it is inflated. Two ridges 30, 30 are integrally provided in a projecting manner on the inner surface of the rear cover member 17. The ridges 30, 30 are formed to connect opposite sides of the horizontally extending groove-shaped tear line 28b to each other, and the tear line 28b is embedded at the ridges 30, 30.

Thus, when a driver pushes any point of the rear cover member 17 of the steering wheel 2 to operate the horn, the rear cover member 17 is slid forwards with the elongated bores 17b being guided by the guide projections 15d of the module-supporting member 15, while compressing the coil springs 48. When any of three pairs of the movable and stationary contacts 46 and 49 are brought into contact each other, the switches 29 for the horn are closed to operate the horn. The rigidity of the rear cover member 17 is lower at the tear lines 28a, 28b and 28c, but the ridges 30, 30 projectingly provided to cross the tear line 28b function to enhance the rigidity of the rear cover member 17. Therefore, when the driver has pushed the rear cover member 17 to operate the horn, deformation of the rear cover member 17 can be prevented, whereby the smooth sliding movement of the rear cover member 17 can be achieved. Moreover, the tear lines 28a, 28b and 28c are formed in the inner surface of the rear cover member 17 and are not exposed to the outside and hence, cannot impair the aesthetic appearance of the cover.

When an acceleration equal to or higher than a predetermined value occurs upon collision of the vehicle, the inflator 20 is ignited, and the air bag 21 expanded by the gas generated by the inflator 20 breaks the tear lines 28a, 28b and 28c in the rear cover member 17 and pushes two lids 31, 31 surrounded by the tear lines 28a, 28b and 28c open to deploy into the vehicle passenger compartment. At this time, the ridges 30, 30 crossing the tear line 28b are also broken with breaking of the central tear line 28b, thereby enabling the air bag 21 to deploy without hindrance.

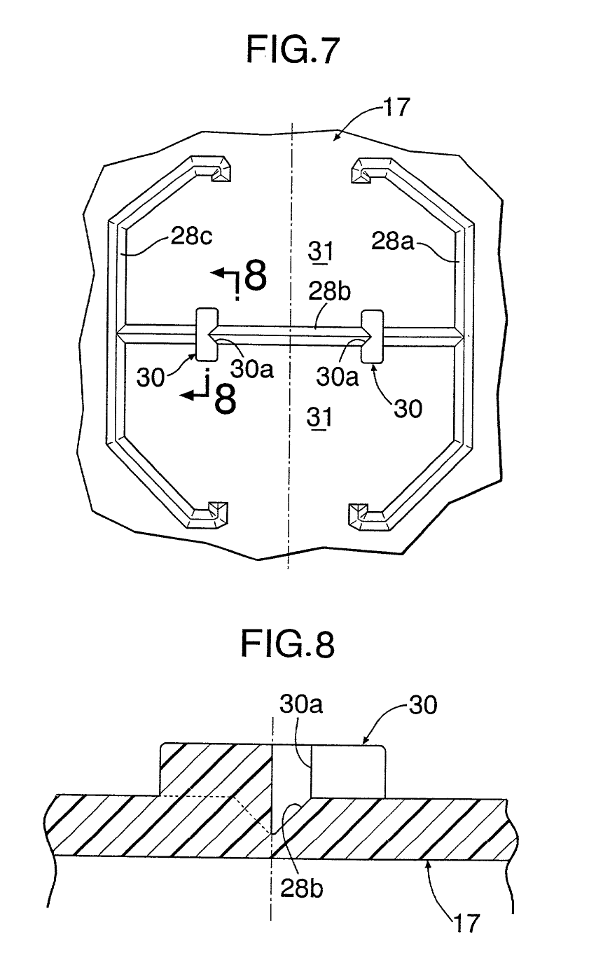

A second embodiment of the present invention will be described with reference to FIGS. 7 and 8.

In the second embodiment, the shapes of the ridges 30, 30 include flat upper and side surfaces, rather from curved surfaces as in the first embodiment. Also, grooves 30a, 30a having a V-shaped section are defined in laterally inner side faces of ridges 30, 30 to reach a bottom of a tear line 28b. The grooves 30a, 30a ensure that the ridges 30, 30 can be broken further reliably upon expansion of the air bag, with almost no change in the rigidity enhancing effect of the ridges 30, 30.

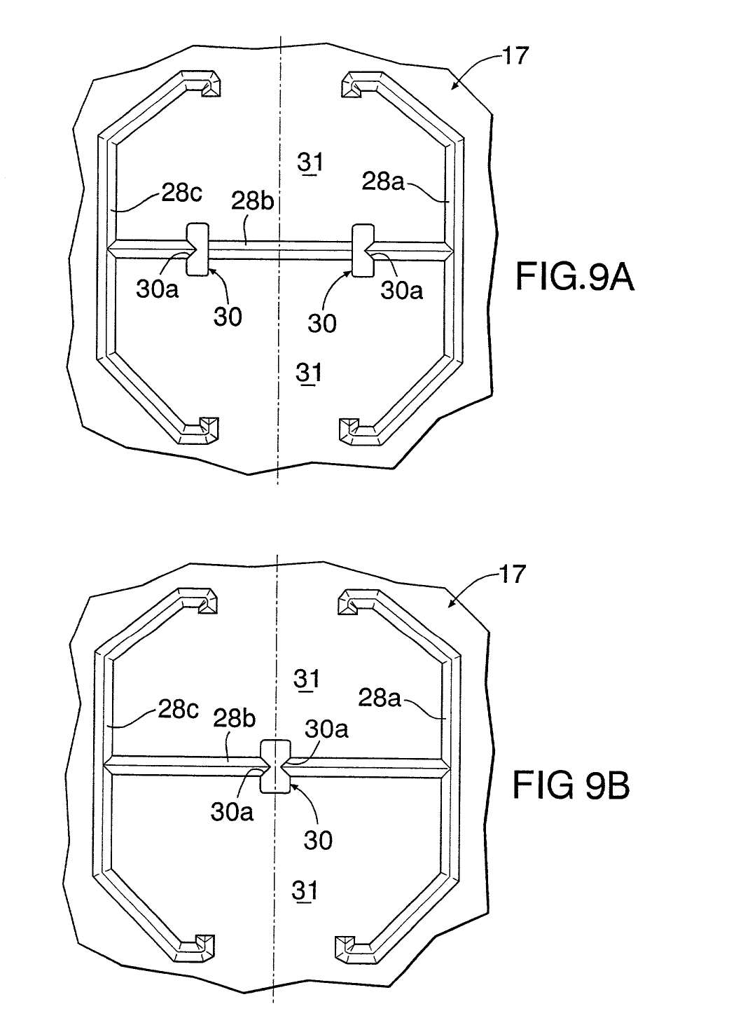

The third and fourth embodiments of the present invention will be described with reference to FIGS. 9A and 9B.

In the third embodiment shown in FIG. 9A, grooves 30a, 30a, similar to those in the second embodiment, are defined in laterally outer side faces of ridges 30, 30. The ridges 30 have the same basic shape as the ridges 30 of the second embodiment, except that the grooves 30 are in the laterally outer faces of the ridges rather than in the laterally inner faces of the ridges.

In the fourth embodiment shown in FIG. 9B, a single larger ridge 30 is provided at a central portion of a tear line 28b, and grooves 30a, 30a are defined in laterally opposite sides of the ridge 30. Even according to the third and fourth embodiments, an effect similar to that in the second embodiment is achieved.

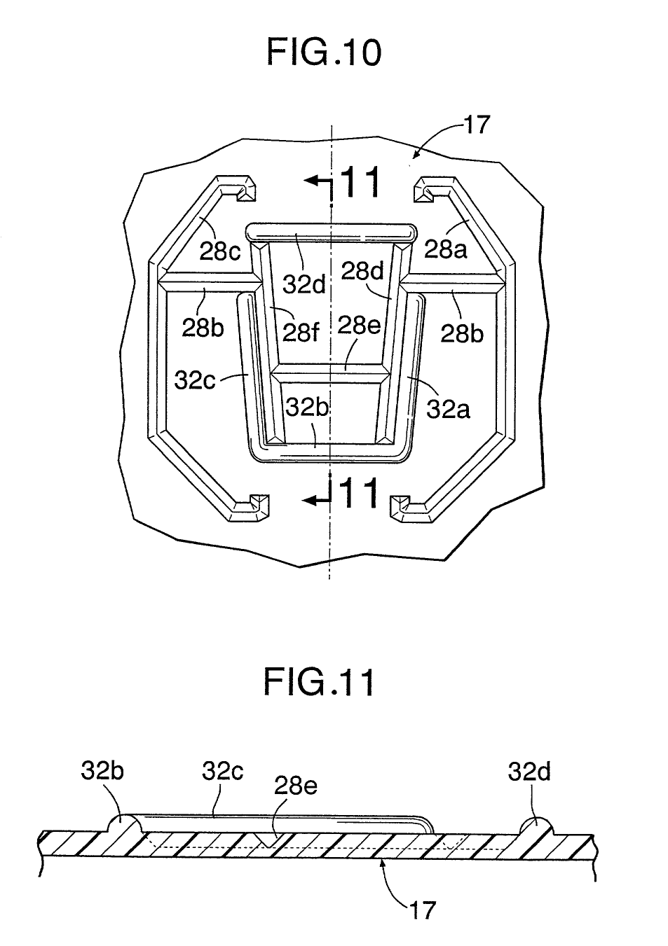

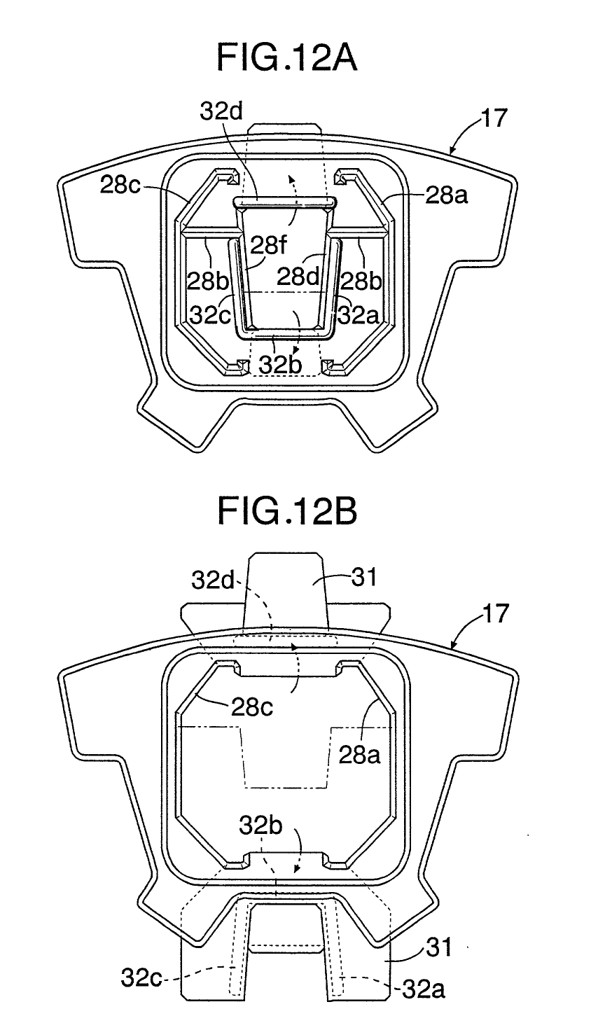

A fifth embodiment of the present invention will be described with reference to FIGS. 10 to 12.

The shapes of tear lines 28a to 28f formed in an inner surface of a rear cover member 17 are different from those in the first to fourth embodiments. Other H-shaped tear lines 28d, 28e and 28f are provided inside tear lines 28a, 28b and 28c corresponding to the tear lines 28a, 28b and 28c in each of the first to fourth embodiments. Further, two reinforcing ribs 32a and 32c are integrally provided in a projecting fashion to extend along laterally outer sides of the two vertically extending tear lines 28d and 28f, and are connected their lower ends to each other by a laterally extending reinforcing rib 32b, whereby the reinforcing ribs 32a, 32b and 32c are formed in a U-shape as a whole. In addition, the two vertically extending tear lines 28d and 28f are connected at their upper ends to each other by a single laterally extending reinforcing rib 32d.

Thus, even according to the fifth embodiment, a reduction in rigidity of the rear cover member 17 due to the formation of the tear lines 28a to 28f can be compensated for by the reinforcing effect of the reinforcing ribs 32a to 32d and hence, the failure of the operation of the switches 29 due to the deformation of the rear cover member 17 can be prevented reliably. Particularly, the two reinforcing ribs 32a and 32c can exhibit the large reinforcing effect to effectively enhance the rigidity of the rear cover member 17, because they are formed to extend along the two tear lines 28d and 28f.

When the air bag 21 is expanded, the central H-shaped tear lines 28d to 28f are first broken, and the breaking of left and right ones 28d and 28f of these H-shaped tear lines 28d to 28f is inhibited at upper end lower ends by the reinforcing ribs 32b and 32d. Then, the outer H-shaped tear lines 28a to 28c are broken to open the lids 31, 31, and the air bag 21 deploys through such openings.

As discussed above, according to the first aspect and feature of the present invention, the ridge is formed on the inner surface of the cover member astride one of the tear lines to enhance the rigidity of the cover member. Therefore, when the cover member is pushed, it can be slid relative to the module-supporting member without being deformed, thereby properly operating the switch. The ridge protrudes from a back hidden surface of the cover member and hence, the rigidity of the cover member is enhanced, but the aesthetic appearance of the cover member is not impaired. When the air bag is expanded to break the tear lines, the ridge provided astride the tear line is also broken and hence, the air bag can be deployed without hindrance.

According to the second aspect and feature of the present invention, the groove is defined in the side of the ridge and connected to the bottom of the tear line and hence, when the tear lines are broken, the ridge can be broken reliably although the rigidity enhancing effect of the ridge on the cover member is not reduced.

According to the third aspect and feature of the present invention, the reinforcing ribs are integrally formed on the inner surface of the cover member, so that they do not intersect the tear lines, thereby enhancing the rigidity of the cover member. Therefore, when the cover member is pushed, it can be slid relative to the module-supporting member without being deformed, thereby properly operating the switch. When the air bag is expanded to break the tear lines, the reinforcing ribs, which do not intersect the tear lines, do not impede the breaking of the tear lines and hence, it is possible to deploy the air bag without hindrance. Moreover, the reinforcing ribs are formed on the inner surface of the cover member and hence, the aesthetic appearance of the cover member is not impaired.

According to the fourth aspect and feature of the present invention, at least a portion of the reinforcing ribs is formed to extend along the tear lines and hence, portions of the cover member in the vicinity of the tear lines can be reinforced by the reinforcing ribs, whereby the rigidity of the cover member can be enhanced effectively.

Although the embodiments of the present invention have been described in detail, it will be understood that various modifications in design may be made without departing from the subject matter of the present invention.

For example, the shapes and numbers of the ridges 30, 30 and the reinforcing ribs 32a to 32d are not limited to those in the embodiments and may be changed as desired. The switches 29 are not limited to those for the horn and may be for any other application.

We claim:

1. An air bag device for a vehicle comprising:
an air bag module including an air bag and an inflator formed integrally with each other,
a module-supporting member mounted at a central portion of a steering wheel for supporting said air bag module,
a cover member slidably supported on the module-supporting member to cover said air bag module,
a switch which operates when the cover member is pushed and slid relative to the module-supporting member, and
groove-shaped tear lines formed in an inner surface of the cover member, so that said air bag, as expanded by a high-pressure gas generated by said inflator upon collision of the vehicle breaks the cover member along the tear lines to deploy into a passenger compartment of the vehicle,
said cover member having at least one ridge integrally formed on the inner surface thereof astride at least one of the tear lines.

2. An air bag device according to claim 1, wherein a groove is defined in a side face of said ridge and extends to a bottom of said at least one tear line.

3. An air bag device for a vehicle comprising:
an air bag module including an air bag and an inflator formed integrally with each other,
a module-supporting member mounted at a central portion of a steering wheel for supporting said air bag module,
a cover member slidably supported on the module-supporting member to cover said air bag module,
a switch which operates when the cover member is pushed and slid relative to the module-supporting member, and
groove-shaped tear lines formed in an inner surface of the cover member, so that said air bag expanded by a high-pressure gas generated by said inflator upon collision of the vehicle breaks the cover member along the tear lines to deploy into a passenger compartment of the vehicle,
said cover member having reinforcing ribs integrally formed on the inner surface thereof, so that they do not intersect the tear lines.

4. An air bag device according to claim 3, wherein at least a portion of said reinforcing ribs extend along at least one of said tear lines.

5. An air bag device according to claim 1, wherein said at least one tear line extends across a central portion of said cover member.

6. An air bag device according to claim 5, wherein said at least one ridge is disposed at an intermediate portion of said at least one tear line.

7. A cover member for an air bag device disposed with a steering wheel having an activating switch provided therewith, the air bag device including an air bag module having an air bag and an inflator formed integrally with each other, a module-supporting member mounted at a central portion of the steering wheel for supporting said air bag module, wherein:
said cover member is slidably supported on the module-supporting member to cover said air bag module and said switch,
said cover member operates said switch when the cover member is pushed and slid relative to the module-supporting member,
said cover member has groove-shaped tear lines formed in an inner surface thereof to assure that said air bag reliably breaks the cover member along the tear lines when it is inflated by said inflator, and
said cover member has at least one rigidity enhancing member integrally formed on the inner surface thereof to assure sufficient rigidity of the cover member during normal use.

8. A cover member according to claim 7, wherein said rigidity enhancing member comprises a ridge integrally formed on the inner surface of the cover member astride one of the tear lines.

9. A cover member according to claim 8, further including a groove defined in a side face of said ridge for assuring that said ridge breaks together with said tear line upon inflation of the air bag.

10. A cover member according to claim 8, wherein said ridge extends to a bottom of said tear line.

11. A cover member according to claim 8, wherein said one of the tear lines extends across a central portion of said cover member.

12. A cover member according to claim 8, wherein said ridge is disposed at an intermediate portion of said one tear line.

13. A cover member according to claim 7, wherein said rigidity enhancing member comprises a reinforcing rib integrally formed on the inner surface of the cover member, said reinforcing rib does not intersect said tear lines.

14. A cover member according to claim 13, including a plurality of said reinforcing ribs integrally formed on the inner surface of the cover member, said reinforcing ribs do not intersect said tear lines.

15. A cover member according to claim 14, wherein at least portions of said reinforcing ribs extend along at least one of said tear lines.

16. A cover member according to claim 14, wherein at least portions of said reinforcing ribs extend substantially perpendicular to least one of said tear lines.

17. An air bag device according to claim 1, wherein said reinforcing ribs substantially surround those of said tear lines disposed in a central portion of said cover member.
